(19) United States
(12) Patent Application Publication
(10) Pub. No.: US 2017/0084925 A1
(43) Pub. Date: Mar. 23, 2017

(54) CHARGE STORAGE DEVICE INCLUDING MIXTURE OF SEMICONDUCTOR PARTICLES AND INSULATOR PARTICLES

(71) Applicant: Panasonic Intellectual Property Management Co., Ltd., Osaka (JP)

(72) Inventors: SHIGEO YOSHII, Aichi (JP); NORIHITO FUJINOKI, Osaka (JP); HARUHIKO HABUTA, Osaka (JP)

(21) Appl. No.: 15/245,259

(22) Filed: Aug. 24, 2016

(30) Foreign Application Priority Data
Sep. 18, 2015 (JP) 2015-185375

(51) Int. Cl. H01M 4/66; H01M 10/054; H01M 10/02; H01M 10/0525

(52) U.S. Cl. CPC H01M 4/666; H01M 10/0525; H01M 10/054; H01M 10/02; H01M 4/661; H01M 4/66

(57) ABSTRACT

A charge storage device includes: a first electrode; a second electrode; a charge storage layer disposed between the first electrode and the second electrode; and an oxide layer disposed between the second electrode and the charge storage layer. The charge storage layer contains a mixture of semiconductor particles and insulator particles. An average particle size of the insulator particles is greater than or equal to the average particle size of the semiconductor particles.

### BACKGROUND

1. Technical Field

The present disclosure relates to a charge storage device and a method for producing the charge storage device.

2. Description of the Related Art

International Publication WO 2012/046325 discloses a multilayer secondary battery that includes a first electrode, a n-type semiconductor layer, a charging layer, a p-type semiconductor layer, and a second electrode. The charging layer is filled with n-type semiconductor fine particles covered with an insulating film. A method for forming the charging layer includes a firing step at a temperature in the range of 300° C. to 400° C.

### SUMMARY

A charge storage device according an aspect of the present disclosure includes: a first electrode; a second electrode; a charge storage layer disposed between the first electrode and the second electrode; and an oxide layer disposed between the second electrode and the charge storage layer. The charge storage layer contains a mixture of semiconductor particles and insulator particles. An average particle size of the insulator particles is greater than or equal to an average particle size of the semiconductor particles.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of a charge storage device according to an embodiment;

FIG. 2 is a schematic view of a charge storage layer in a charge storage device according to an embodiment;

FIG. 3A is a flow chart of a method for producing a charge storage device according to an embodiment;

FIG. 3B is a flow chart of a step of forming a charge storage layer in a method for producing a charge storage device according to an embodiment;

FIG. 4 is a schematic cross-sectional view of a charge storage device according to an embodiment;

FIG. 5 is a transmission electron micrograph of a cross section of a charge storage layer according to Example 1;

FIG. 6 is a magnified image of the micrograph of FIG. 5;

FIG. 7 is a transmission electron micrograph of a cross section of a charge storage layer according to a comparative example; and

FIG. 8 is a graph of the discharging characteristics of a charge storage device according to Example 2.

### DETAILED DESCRIPTION

### Overview of Embodiments

A charge storage device according an embodiment of the present disclosure includes: a first electrode; a second electrode; a charge storage layer disposed between the first electrode and the second electrode; and an oxide layer disposed between the second electrode and the charge storage layer. The charge storage layer contains a mixture of semiconductor particles and insulator particles. An average particle size of the insulator particles is greater than or equal to an average particle size of the semiconductor particles.

This charge storage device can have high performance (for example, high storage capacity). This charge storage device can be produced by a low-temperature process, for example.

The semiconductor particles may be dispersed among the insulator particles. The insulator particles may have an average particle size at least twice or not more than four times the average particle size of the semiconductor particles. The insulator particles may have an average particle size in the range of 5 to 100 nm, 1 to 20 nm, or 2 to 10 nm.

This enables semiconductor particles to come into contact with each other, thus ensuring the conduction path of carriers, such as electron and/or ions, in the charge storage device.

The material of the insulator particles may be silicon oxide. Silicon oxide is chemically stable and relatively inexpensive.

The material of the semiconductor particles may be titanium oxide. Titanium oxide is chemically stable and relatively inexpensive.

The charge storage layer and the oxide layer may be formed of a solid material. The charge storage device may be an all-solid charge storage device.

The charge storage device may further include a substrate having a heat resistant temperature of 250° C. or less. A low-temperature process for producing a charge storage device increases the choice of the material of the substrate and increases design flexibility.

The term “heat resistant temperature”, as used herein in the context of metal substrates, refers to the temperature at which the smoothness or electrical conductivity of a surface of a metal substrate begins to deteriorate due to heating in air. Such deterioration is caused by oxidation of metal, for example. The term “heat resistant temperature”, as used herein in the context of resin substrates, refers to the softening temperature of resin.

The substrate may be formed of aluminum, copper, or resin. Aluminum substrates are lightweight and have high strength and processability. Copper substrates have high electric conductivity and processability. Resin substrates are lightweight and flexible.

A production method according to an embodiment of the present disclosure includes: forming a first electrode; forming a charge storage layer containing a mixture of semiconductor particles and insulator particles; forming an oxide layer; and forming a second electrode. The forming of the charge storage layer includes: applying a dispersion liquid containing the semiconductor particles and the insulator particles to the first electrode or the oxide layer; and heating the coating film to form the charge storage layer. The insulator particles have an average particle size greater than or equal to the average particle size of the semiconductor particles.

By the production method, the mixed state of semiconductor particles and insulator particles can be maintained while the charge storage layer is thoroughly dried. Furthermore, the substrate can be prevented from deteriorating at a heating temperature of 250° C. or less.

For example, when the substrate is a resin substrate, deformation and strength reduction of the substrate due to heating can be prevented. Resin substrates are inexpensive and lightweight. Thus, use of a resin substrate can reduce the cost of a charge storage device and increase the capacity of a charge storage device per unit weight. If the resin substrate is flexible, the charge storage device can also be flexible.

For exapmle, when the substrate is a copper substrate, aluminum substrate, or iron substrate, a surface of the substrate can be prevented from being oxidized by heating. This can suppress an increase in the internal resistance of a charge storage device due to an oxide film. These metal substrates are inexpensive and electrically conductive.

By the production method, owing to a relatively low heating temperature, it may be unnecessary to use equipment required for a high temperature process (for example, a high temperature furnace). This can reduce capital investment and electric power for operating equipment, thus reducing production costs, for example.

Charge storage devices produced by the production method can have the same performance as or higher performance than charge storage devices produced by a known dipping-pyrolysis process. For example, charge storage devices produced by the production method have higher storage capacity.

The coating film may be heated at a heating temperature of 250° C. or less. The heating temperature may be 100° C. or less or 50° C. or more. This enables the charge storage layer to be thoroughly dried and have high quality.

Embodiments of the present disclosure will be described below with reference to the accompanying drawings. The following embodiments are comprehensive or specific embodiments. The numerical values, shapes, materials, and components, as well as the arrangement, connection, and order of production of the components in the following embodiments are only examples and are not intended to limit the present disclosure. Although a material of each member may be represented by a composition formula, the composition formula only indicates the elements of the material and is not intended to limit the material to a particular component ratio. Subscripts in the composition formula may be omitted. Among the components in the following embodiments, components not described in the independent claims are described as optional components.

### Embodiments

### 1. OVERALL STRUCTURE

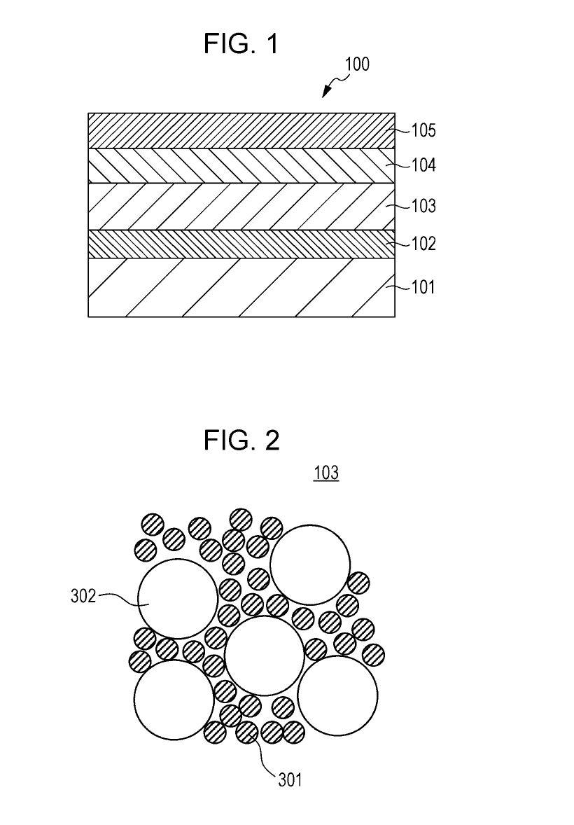

FIG. 1 is a schematic cross-sectional view of a charge storage device 100 according to an embodiment.

As illustrated in FIG. 1, the charge storage device 100 includes a substrate 101, a first electrode 102, a charge storage layer 103, an oxide layer 104, and a second electrode 105. The charge storage layer 103 is disposed between the first electrode 102 and the second electrode 105. The oxide layer 104 is disposed between the second electrode 105 and the charge storage layer 103. The first electrode 102 functions as a first collector, and the second electrode 105 functions as a second collector. The charge storage layer 103 functions as a negative electrode, and the oxide layer 104 functions as a positive electrode.

The substrate 101 may be disposed on the second electrode 105 side. Alternatively, the substrate 101 may be omitted.

The charge storage device 100 may include an intermediate layer between the layers. The intermediate layer may be a diffusion-barrier layer or an electron-injection layer. For example, the diffusion-barrier layer prevents impurities from diffusing from the first electrode 102 to the charge storage layer 103. For example, the diffusion-barrier layer prevents impurities from diffusing from the second electrode 105 to the oxide layer 104. For example, the electron-injection layer efficiently transfers electrons from the first electrode 102 to the charge storage layer 103. For example, the electron-injection layer efficiently transfers electrons from the second electrode 105 to the oxide layer 104.

The first electrode 102, the second electrode 105, the charge storage layer 103, and the oxide layer 104 may be solid. If the charge storage device 100 includes another member, the member may also be solid. The charge storage device 100 composed entirely of solid members is an all-solid charge storage device. All-solid charge storage devices pose no risk of liquid leakage, eliminate the risk of damage to peripheral devices and/or environmental pollution due to liquid leakage, and thus ensure safety. The term “solid”, as used herein, refers to a non-liquid state that can be treated as a solid. Examples of solid materials include solid metals, solid metal oxides, polymeric material gels, and solidified polymeric materials.

The charge storage device 100 in plan view may have any shape and may be rectangular, circular, elliptical, or hexagonal. The charge storage device 100 may include multilayer bodies each composed of the first electrode 102, the second electrode 105, the charge storage layer 103, and the oxide layer 104. Even in such a multilayer structure, a low-temperature process enables an upper layer to be formed without significant heat damage to a lower layer. The charge storage device 100 may be folded by a given method. The charge storage device 100 may be of a cylindrical type, a square type, a button type, a coin type, or a flat type.

The layers of the charge storage device 100 will be described in detail below.

### 2. SUBSTRATE

The substrate 101 may be insulative or electrically conductive. The substrate 101 may be formed of a material of which the physical properties and shape are not changed even when an inorganic layer is formed thereon. The substrate 101 may be a glass substrate, a plastic substrate, a polymer film, a silicon substrate, a metal sheet, a metal foil sheet, or a laminate thereof.

A commercially available substrate may be procured as the substrate 101. Alternatively, the substrate 101 may be produced by a known method.

As described later, a method for producing a charge storage device according to the present embodiment is a low-temperature process. Thus, a resin substrate that is likely to be deformed at high temperatures and/or tends to have low strength at high temperatures can be used as the substrate 101. Alternatively, a copper substrate, an aluminum substrate, or an iron substrate, which is easily oxidized in a high-temperature oxidizing atmosphere, can be used as the substrate 101.

When the heating temperature in the production is 250° C. or less, the substrate 101 may be an aluminum foil substrate, a copper foil substrate, a poly(ether ether ketone) (PEEK) substrate, a polyamideimide (PAI) substrate, or a poly(phenylene sulfide) (PPS) substrate. When the heating temperature in the production is 100° C. or less, the substrate 101 may be a poly(ethylene terephthalate) (PET) substrate or a polycarbonate (PC) substrate.

### 3. FIRST ELECTRODE AND SECOND ELECTRODE

The first electrode 102 and the second electrode 105 are electrically conductive.

The first electrode 102 and the second electrode 105 may be a metal electrode. The material of the metal electrode may be copper (Cu), chromium (Cr), nickel (Ni), titanium (Ti), platinum (Pt), gold (Au), aluminum (Al), tungsten (W), iron (Fe), and/or molybdenum (Mo). The metal electrode contains at least one selected from the group consisting of these metal elements. The metal electrode may be an alloy.

As described later, a method for producing a charge storage device according to the present embodiment is a low-temperature process. Thus, copper, aluminum, and/or iron, which is easily oxidized in a high-temperature oxidizing atmosphere, can be used in the first electrode 102 and/or the second electrode 105.

The first electrode 102 and the second electrode 105 may be a transparent electrode. The material of the transparent electrode may be indium tin oxide (ITO), indium zinc oxide (IZO), fluorine-doped tin oxide (FTO), antimony-doped tin oxide (ATO), indium oxide (In₂O₃), tin oxide (SnO₂), or Al-containing ZnO. The first electrode 102 and the second electrode 105 may be a multilayer film composed of electrically conductive films or a multilayer film composed of an electrically conductive film and a metal film.

The first electrode 102 and the second electrode 105 may be formed by a thin film forming method, such as a chemical deposition method or a physical deposition method. The physical deposition method may be a sputtering method, a vacuum evaporation method, an ion plating method, or a pulsed laser deposition (PLD) method. The chemical deposition method may be a chemical vapor deposition (CVD) method, a liquid phase film forming method, a sol-gel method, a metal organic deposition (MOD) method, or a spray pyrolysis method. The CVD method may be plasma chemical vapor deposition (CVD), thermal CVD, or laser CVD. The liquid phase film forming method may be a wet plating method. The wet plating method may be electroplating, immersion plating, or electroless plating.

Alternatively, the first electrode 102 and the second electrode 105 may be formed by printing with a fine particle dispersion liquid. The printing method may be a doctor blade method, a spin coating method, an ink jet method, or a screen printing method.

The first electrode 102 and the second electrode 105 may be formed by a sputtering method, a vacuum evaporation method, a PLD method, or a CVD method. A film having a uniform thickness and high mechanical strength can be formed at low cost by these methods.

### 4. CHARGE STORAGE LAYER

### 4-1. Structure of Charge Storage Layer

The charge storage layer 103 may be a thin film containing a mixture of semiconductor particles and insulator particles.

FIG. 2 is a schematic view of the charge storage layer 103. As illustrated in FIG. 2, the charge storage layer 103 contains a mixture of semiconductor particles 301 and insulator particles 302. The semiconductor particles 301 are dispersed among the insulator particles 302. Each of the insulator particles 302 is surrounded by the semiconductor particles 301. The semiconductor particles 301 and the insulator particles 302 substantially retain their respective particle shapes. Thus, the structure of the charge storage layer 103 in FIG. 2 is distinct from the structure of a layer containing semiconductor fine particles coated with a continuous insulating film.

The semiconductor particles 301 desirably have an average particle size in the range of 1 to 20 nm, more desirably 2 to 10 nm.

The insulator particles 302 desirably have an average particle size in the range of 5 to 100 nm, more desirably 10 to 50 nm.

The average particle size of the insulator particles 302 is desirably greater than or equal to the average particle size of the semiconductor particles 301, more desirably at least twice the average particle size of the semiconductor particles 301. For example, the average particle size of the insulator particles 302 is not more than four times the average particle size of the semiconductor particles 301.

Such a structure enables the semiconductor particles 301 to come into contact with each other, thus ensuring the conduction path of carriers, such as electrons and/or ions, in the charge storage device 100.

The term “average particle size”, as used herein, refers to an arithmetical mean of diameters of a predetermined number of (for example, 10) particles randomly sampled in an electron micrograph (for example, a transmission electron micrograph). The term “particle diameter”, as used herein, refers to the minimum diameter of a circle surrounding the particle.

The charge storage layer 103 may have a thickness in the range of 50 nm to 10 μm. The charge storage layer 103 desirably has a thickness in the range of 100 nm to 5 μm, more desirably 200 nm to 2 μm.

### 4-2. Insulator Particles

The insulator particles 302 may be crystal grains or amorphous particles.

The insulator particles 302 may have a resistivity of 1×10⁸ Ωm or more. The insulator particles 302 desirably have a resistivity of 1×10¹⁰ Ωm or more, more desirably 1×10¹² Ωm or more. As the insulator particles 302 have higher resistivity, electron leakage in the insulator particles 302 can be more effectively prevented. The resistivity of insulator particles can be estimated from the results of composition analysis, such as electron energy-loss spectroscopy (EELS) or energy dispersive X-ray (EDX) spectroscopy. Alternatively, the resistivity of insulator particles can be determined with a scanning probe microscope equipped with an electrically conductive probe.

The material of the insulator particles 302 may be at least one selected from the group consisting of silicon oxide (SiO₂), aluminum oxide (Al₂O₃), and magnesium oxide (MgO). These materials are chemically stable and relatively inexpensive. The insulator particles 302 may be formed of silicon oxide (SiO₂).

### 4-3. Semiconductor Particles

The semiconductor particles 301 may be crystal grains or amorphous particles.

The semiconductor particles 301 may have a resistivity of 1×10⁻⁶ Ωm or more and less than 1×10⁸ Ωm. The semiconductor particles 301 desirably have a resistivity of 1×10⁻³ Ωm or more and less than 1×10⁶ Ωm, more desirably 1×10⁻¹ Ωm or more and less than 1×10⁴ Ωm. The semiconductor particles 301 having a lower resistivity can form a better conduction path with the first electrode 102. When the semiconductor particles 301 have a resistivity in the range described above, electron leakage between the semiconductor particles 301 and the oxide layer 104 can be effectively reduced, and a good conduction path can be formed between the semiconductor particles 301 and the first electrode 102. The resistivity of the semiconductor particles can be estimated from the results of composition analysis, such as EELS or EDX. Alternatively, the resistivity of the semiconductor particles can be determined with a scanning probe microscope equipped with an electrically conductive probe.

The material of the semiconductor particles 301 may be at least one selected from the group consisting of titanium oxide (TiO₂), tin oxide (SnO), zinc oxide (ZnO), tantalum oxide (Ta₂O₅), niobium oxide (Nb₂O₅), cerium oxide (CeO₂), molybdenum oxide (MoO₃), and tungsten oxide (WO₃). These materials are chemically stable and relatively inexpensive. The material of the semiconductor particles 301 may be titanium oxide (TiO₂). The titanium oxide may have an anatase crystal structure or a rutile crystal structure.

### 4-4. Method for Forming Charge Storage Layer

A method for forming the charge storage layer 103 may include the steps of (a) preparing a dispersion liquid containing the semiconductor particles 301 and the insulator particles 302 dispersed in a predetermined solvent, (b) applying the dispersion liquid to a base to form a coating film, and (c) heating the coating film at a heating temperature of 250° C. or less to dry the coating film. The term “heating temperature”, as used herein, refers to the temperature around the coating film.

In the step (a) of preparing a dispersion liquid, for example, an aqueous solution containing the semiconductor particles 301 dispersed in an aqueous solvent is mixed with an aqueous solution containing the insulator particles 302 dispersed in an aqueous solvent, to prepare an aqueous solution containing the semiconductor particles 301 and the insulator particles 302 dispersed therein. The concentration of the aqueous solution is adjusted such that the coating film formed in the next step (b) has a desired thickness.

When the solvent is composed mainly of water, the surface of the coating film, which is formed in the next step (b), of each particle remains hydrophilic. Thus, the resulting charge storage layer 103 can efficiently transfer various ions. The term “solvent composed mainly of water”, as used herein, means that the water content on a mass basis is highest in the solvent.

The dispersion liquid may further contain a dispersant, a surfactant, an amphiphilic molecule, a water-soluble alcohol, and/or a water-soluble ketone. This can improve dispersion of particles in the dispersion liquid and/or increase the evaporation rate of the solvent in the subsequent step (c).

The surface of the semiconductor particles 301 may be treated with a dispersant or surfactant before the semiconductor particles 301 are dispersed in the solvent. Likewise, the surface of the insulator particles 302 may be treated with a dispersant or surfactant before the insulator particles 302 are dispersed in the solvent.

The dispersant may be a silane coupling agent. The water-soluble alcohol may be ethanol, methanol, or propanol. The water-soluble ketone may be acetone or acetylacetone.

The step (a) of preparing a dispersion liquid may be a step of procuring a prepared dispersion liquid.

In the step (b) of forming a coating film, various methods, such as a coating method or a printing method, may be used. The coating method may be a spin coating method, a casting method, a gravure coating method, a bar coating method, a roll coating method, a wire bar coating method, a dip coating method, a slit coating method, a capillary coating method, a spray coating method, or a nozzle coating method. The printing method may be a gravure printing method, a screen printing method, a flexographic printing method, an offset printing method, a reverse printing method, or an ink jet method.

In the step (c) of drying the coating film, the coating film is heated at a relatively low temperature (e.g., 250° C. or less). This enables the coating film to be dried while maintaining the mixed state of the semiconductor particles 301 and the insulator particles 302 and suppressing degradation of the substrate 101 and the first electrode 102. Consequently, the charge storage layer 103 can be of high quality. The heating temperature may be 100° C. or less.

The heating temperature may be 50° C. or more. This can facilitate drying and reduce variations in the thickness of the charge storage layer 103.

The method for forming the charge storage layer 103 may further include a step (d) of irradiating the charge storage layer 103 with ultraviolet light after the step (c). This can reduce the amount of residues, such as a hydrocarbon dispersant. An ultraviolet irradiation apparatus, such as a high-pressure mercury lamp, a low-pressure mercury lamp, or a YAG laser, may be used. The irradiation time can be decreased with increasing irradiation energy density.

### 5. OXIDE LAYER

The oxide layer 104 may contain at least one of oxides and hydroxides having a standard electrode potential of −0.1 V or more when the at least one of oxides and hydroxides donates electrons as a reducing agent. For example, the oxide layer 104 contains at least one of nickel (II) oxide (NiO), nickel hydroxide (Ni(OH)₂), and copper aluminum oxide (CuAlO₂) as a main component. Alternatively, the oxide layer 104 may contain at least one of oxides and hydroxides having a standard electrode potential of −0.1 V or more when the at least one of oxides and hydroxides accepts electrons as an oxidizing agent. For example, the oxide layer 104 contains at least one of nickel (III) oxide (Ni₂O₃) and nickel oxyhydroxide (NiOOH) as a main component. The upper limit of the standard reduction potential and the upper limit of the standard oxidation potential are not particularly limited and may be 1.7 V.

The oxide layer 104 may be formed by a thin film forming method, such as a chemical deposition method or a physical deposition method. The physical deposition method may be a sputtering method, a vacuum evaporation method, an ion plating method, or a PLD method. The chemical deposition method may be a CVD method, a liquid phase film forming method, a sol-gel method, a MOD method, or a spray pyrolysis method. The CVD method may be plasma chemical vapor deposition (CVD), thermal CVD, or laser CVD. The liquid phase film forming method may be a wet plating method. The wet plating method may be electroplating, immersion plating, or electroless plating.

Alternatively, the oxide layer 104 may be formed by printing with a fine particle dispersion liquid. The printing method may be a doctor blade method, a spin coating method, an ink jet method, or a screen printing method.

The oxide layer 104 may be formed by a sputtering method, a vacuum evaporation method, a PLD method, or a CVD method. A film having a uniform thickness and high mechanical strength can be formed at low cost by these methods.

### 6. OPERATION

Charging and discharging operations of the charge storage device 100 will be described below.

First, the charging operation will be described below. While the first electrode 102 is grounded, and the second electrode 105 is coupled to an external power supply (not shown), a positive voltage is applied to the second electrode 105 from an external electrode. A charging current flows from the external power supply to the second electrode 105, and thereby energy is stored in the charge storage device 100. Thus, the charge storage device 100 is charged. The charged state is maintained even after the application of voltage is stopped.

Next, the discharging operation will be described below. When a load is coupled to the first electrode 102 and the second electrode 105, a discharge current flows from the second electrode 105 to the first electrode 102 via the load. Energy is released from the charge storage device 100. Thus, the charge storage device 100 is discharged.

The charge storage device 100 can perform the charging and discharging operations multiple times.

The charge storage device 100 can store energy through ionic conduction and a redox reaction. The charge storage device 100 may also store energy by accumulating electric charges in interfaces in the charge storage device 100.

### 7. METHOD FOR PRODUCING CHARGE STORAGE DEVICE

A method for producing a charge storage device according to the present embodiment will be described below.

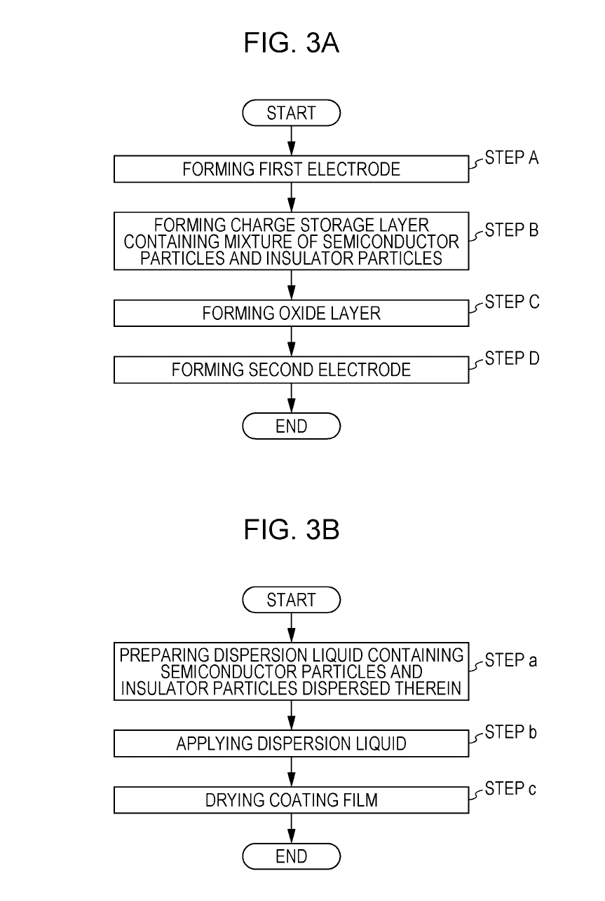

FIG. 3A is a flow chart of a method for producing the charge storage device 100. The production method illustrated in FIG. 3A includes the steps of (A) forming the first electrode 102, (B) forming the charge storage layer 103 containing a mixture of the semiconductor particles 301 and the insulator particles 302, (C) forming the oxide layer 104, and (D) forming the second electrode 105.

FIG. 3B is a flow chart of a specific example of the step of forming the charge storage layer 103 illustrated in FIG. 3A. The steps a to c in FIG. 3B may be the steps (a) to (c) described in Section 4-4.

In the step A, the first electrode 102 is formed on the substrate 101, for example, by a sputtering method. If the substrate 101 is formed of an electrically conductive material and functions as the first electrode 102, the step A may be omitted.

In the step B, the charge storage layer 103 is formed on the first electrode 102. For example, the step B includes the steps a to c.

In the step a, an aqueous solution containing the semiconductor particles 301 dispersed in an aqueous solvent is mixed with an aqueous solution containing the insulator particles 302 dispersed in an aqueous solvent, to prepare an aqueous solution (i.e., dispersion liquid) containing the semiconductor particles 301 and the insulator particles 302 dispersed therein. The concentration of the dispersion liquid is adjusted such that a coating film having a desired thickness can be formed in the next step b.

In the step b, the aqueous solution is applied to the first electrode 102 to form a coating film. When a spin coating method is used, the substrate 101 is fixed on a spinner, the aqueous solution is dropped on the first electrode 102, and then the substrate 101 is rotated to form a coating film. A thin layer having a thickness in the range of 0.3 to 3 μm depending on the rotational speed of the substrate 101 is formed on the first electrode 102, for example.

In the step c, the substrate 101 on which the coating film has been formed is heated, for example, in the air at a heating temperature in the range of 50° C. to 250° C. for approximately 70 minutes. The coating film is dried and thus forms the charge storage layer 103.

After the step c, the charge storage layer 103 may be irradiated with ultraviolet light. This can reduce the amount of residues, such as a dispersant, and therefore increase the strength of the charge storage layer 103. For example, the charge storage layer 103 may be irradiated with ultraviolet light at room temperature for approximately 30 to 240 minutes. The ultraviolet light may have a wavelength of 254 nm and an intensity of 100 mW/cm². The step of ultraviolet irradiation may be omitted.

In the step B of forming the charge storage layer 103, the steps a to c may be performed multiple times. This can adjust the thickness of the charge storage layer 103.

In the step C, the oxide layer 104 is formed on the charge storage layer 103, for example, by a sputtering method.

In the step D, the second electrode 105 is formed, for example, by a sputtering method.

The charge storage device 100 is produced through these steps.

### 8. MODIFIED EXAMPLE

### 8-1. Modified Example 1

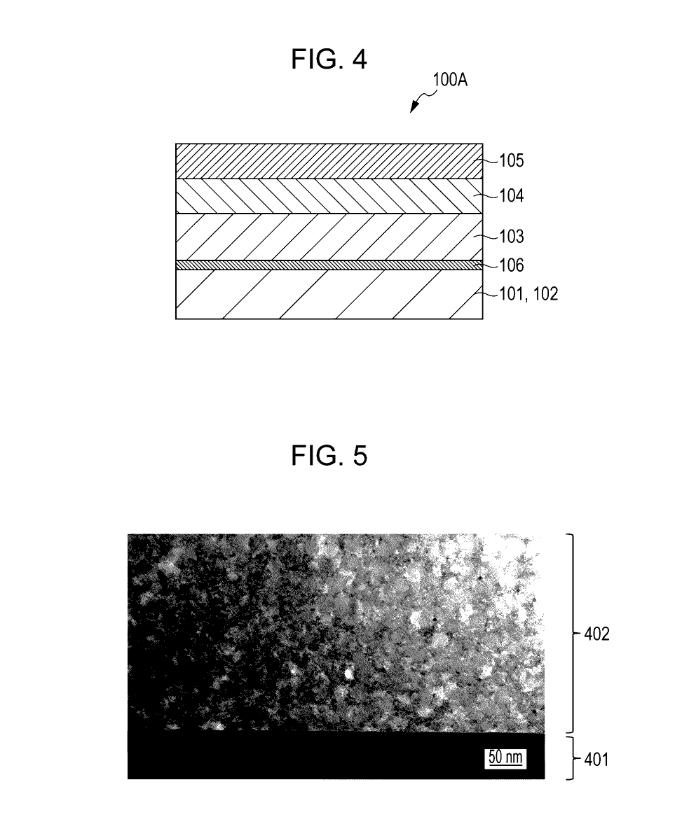

FIG. 4 illustrates a charge storage device 100A according to Modified Example 1 of the present embodiment. The charge storage device 100A includes a substrate 101, an underlayer 106, a charge storage layer 103, an oxide layer 104, and a second electrode 105. The charge storage device 100A in FIG. 4 is different from the charge storage device 100 illustrated in FIG. 1 in that the substrate 101 also functions as a first electrode 102 and that the underlayer 106 is formed on the substrate 101. The charge storage device 100A may include an intermediate layer between the layers.

The substrate 101 is electrically conductive. The substrate 101 may be a stainless steel substrate. In other words, the first electrode 102 may be a stainless steel electrode.

The underlayer 106 may contain tungsten oxide. The underlayer 106 containing tungsten oxide may be formed with a sputtering apparatus by reactive sputtering. For example, the substrate 101 is placed in a vacuum chamber of the sputtering apparatus. The vacuum chamber is set at a predetermined temperature (for example, at room temperature). While an inert gas (for example, argon gas) and a minute amount of oxygen gas are introduced into the vacuum chamber, sputtering is performed with a tungsten target. Consequently, tungsten oxide is deposited on the substrate 101 and thus forms the underlayer 106.

### 8-2. Modified Example 2

In a charge storage device according to the present embodiment, conductive ionic species contributing to charging and discharging operations may be protons or may be lithium ions, sodium ions, or magnesium ions.

In a charge storage device according to Modified Example 2, ion conducting species are lithium ions. The charge storage device according to Modified Example 2 includes a first electrode, a second electrode, a charge storage layer, an electrolyte layer containing lithium, and an oxide layer containing lithium.

The charge storage layer contains a mixture of semiconductor particles and insulator particles, as in the charge storage layers described above.

The electrolyte layer is disposed between the charge storage layer and the oxide layer. The material of the electrolyte layer may be lithium phosphate oxynitride (LiPON), amorphous lithium borosilicate (amorphous LiSiBO), amorphous lithium phosphosilicate (amorphous LiSiPO), lithium lanthanum titanate (LiLaTiO), lithium lanthanum zirconate (LiLaZrO), or lithium aluminum titanium phosphate (LiAITiPO). The electrolyte layer may have a thickness in the range of 200 to 800 nm. The electrolyte layer may be formed with a radio-frequency sputtering apparatus at room temperature.

The material of the oxide layer may be lithium cobalt oxide (LiCoO₂), lithium manganese oxide (LiMn₂O₄), lithium iron phosphate (LiFePO₄), amorphous lithium nickel phosphate (amorphous LiNiPO), or amorphous lithium manganese phosphate (amorphous LiMnPO). The oxide layer may have a thickness in the range of 500 to 2000 nm. The oxide layer may be formed with a radio-frequency sputtering apparatus at room temperature.

### 9. EXPERIMENTAL RESULTS

The experimental results of a charge storage device according to the present embodiment will be described below with reference to FIGS. 5 to 8. The present disclosure is not limited to the following specific conditions and results.

### 9-1. Structure of Charge Storage Layer

In order to examine the structure of a charge storage layer according to the present embodiment, a sample 1 that included only a charge storage layer on a silicon substrate was prepared, and then the cross-sectional structure of the sample 1 was examined. The charge storage layer of the sample 1 is assumed to have the same structure as the charge storage layer of the charge storage device according to the present embodiment. In order to compare this example, a sample 2 that included a charge storage layer formed by a known method was prepared as a comparative example, and then the cross-sectional structure of the sample 2 was examined.

### 9-1-1. Preparation of Sample 1

The sample 1 was prepared through the following procedures.

An aqueous solution containing titanium oxide (TiO₂) particles having an average particle size of 5 nm dispersed in an aqueous solvent was mixed with an aqueous solution containing silicon oxide (SiO₂) particles having an average particle size of 20 nm dispersed in an aqueous solvent. Thus, an aqueous solution containing dispersed titanium oxide particles and silicon oxide particles was prepared. The titanium oxide particles corresponded to the semiconductor particles 301, and the silicon oxide particles corresponded to the insulator particles 302.

The average particle size of each particle was determined by observation with a transmission electron microscope. The titanium oxide particles had an anatase crystal structure. The mass ratio of the titanium oxide particles to the silicon oxide particles was 1:2. It was confirmed that the titanium oxide particles and the silicon oxide particles were stably and uniformly dispersed in the aqueous solution.

The aqueous solution was then applied to a silicon substrate and formed a coating film having a thickness of approximately 0.4 μm. A spin coating method was used. More specifically, the aqueous solution was dropped on a silicon substrate fixed on a spinner, and the silicon substrate was rotated to form a coating film. The rotational speed of the spinner was 2000 rpm, and the rotation time was approximately 10 seconds.

The silicon substrate on which the coating film had been formed was then heated in the air at a heating temperature of 100° C. for 70 minutes. Thus, the coating film was dried and formed a charge storage layer. A hot plate was used for heating. The present inventors confirmed that almost the same charge storage layer as the sample 1 was formed at a heating temperature of 50° C.

Finally, the charge storage layer was irradiated with ultraviolet light. More specifically, a low-pressure mercury lamp was used, and the charge storage layer was irradiated for 120 minutes with ultraviolet light having a wavelength of 254 nm and an intensity of approximately 80 mW/cm².

### 9-1-2. Cross-Sectional Structure of Sample 1

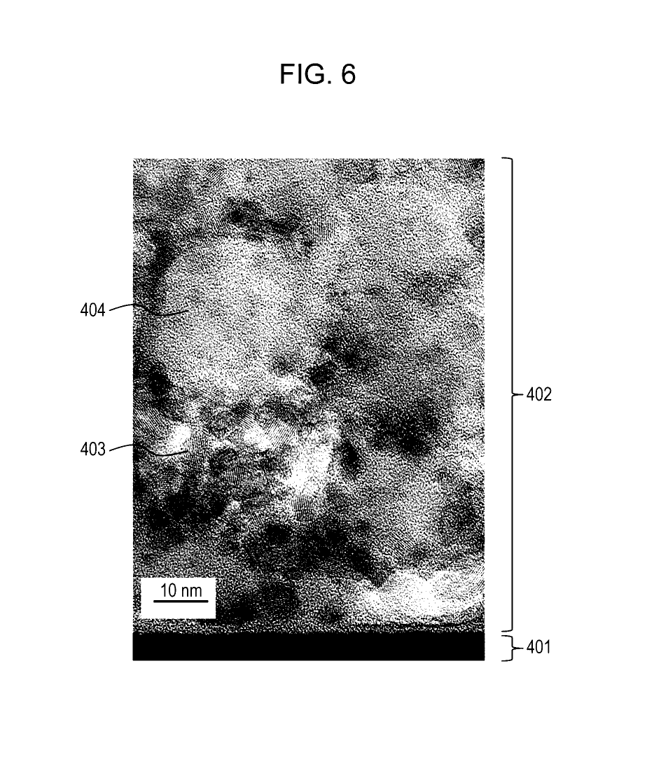

The sample 1 was cut, and then a cross section was observed with a transmission electron microscope. FIG. 5 is an image of the cross section of the sample 1, and FIG. 6 is a magnified image of part of the image.

As shown in FIG. 5, a charge storage layer 402 was observed on a silicon substrate 401. As shown in FIG. 6, titanium oxide particles 403 with relatively high contrast and silicon oxide particles 404 with relatively low contrast were observed in the charge storage layer 402. In FIG. 6, definite boundaries (i.e., interfaces) were observed between the titanium oxide particles 403 and the silicon oxide particles 404. The titanium oxide particles 403 and the silicon oxide particles 404 were accumulated while maintaining their particle shape.

The silicon oxide particles 404 did not have a lattice pattern. Thus, the silicon oxide had an amorphous structure. The titanium oxide particles 403 had a lattice pattern. The lattice pattern was the same as the lattice pattern of anatase titanium oxide crystals. Thus, the titanium oxide particles 403 had an anatase structure.

### 9-1-3. Preparation of Sample 2

The sample 2 was prepared through the following procedures.

A solution of titanium monocarboxylate in xylene was mixed with silicone oil to prepare a coating liquid.

The coating liquid was applied to a silicon substrate to form a coating film. More specifically, spin coating was performed at a rotational speed of 2000 rpm for 10 seconds.

The silicon substrate on which the coating film had been formed was heated in the air at a temperature of approximately 50° C. for 10 minutes and was then fired at a temperature of approximately 500° C. for 60 minutes. Thus, a charge storage layer containing a mixture of titanium oxide and silicon oxide was formed. A hot plate was used for heating.

Finally, the charge storage layer was irradiated with ultraviolet light. More specifically, a low-pressure mercury lamp was used, and the charge storage layer was irradiated for 120 minutes with ultraviolet light having a wavelength of 254 nm and an intensity of approximately 80 mW/cm².

### 9-1-4. Cross-Sectional Structure

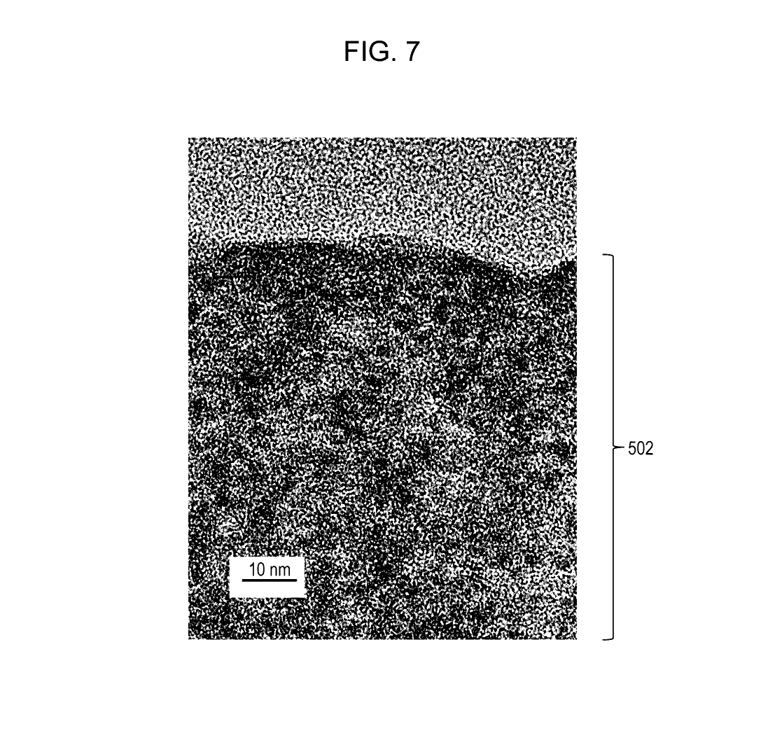

The sample 2 was cut, and then a cross section was observed with a transmission electron microscope. FIG. 7 is an image of the cross section of the sample 2. The images in FIGS. 6 and 7 had the same magnification. Unlike the image in FIG. 6, the image in FIG. 7 had no clear particle shape. In FIG. 7, there were high and low contrast portions in a charge storage layer 502. This indicates coexistence of a high titanium oxide concentration region and a high silicon oxide concentration region. However, there was no definite interface between these regions. Thus, the charge storage layer of the sample 2 had a smooth concentration distribution.

As is clear from these results, the structure of a charge storage layer according to the present embodiment is distinct from the structure of a charge storage layer formed by a known method.

### 9-2. Heating Temperature and Charge-Discharge Characteristics

In order to examine the charge-discharge characteristics of a charge storage device according to the present embodiment, samples A and B were prepared as examples of the charge storage device, and a sample C was prepared as a comparative example of the charge storage device. The samples A to C had the same multilayer structure as the charge storage device 100A illustrated in FIG. 4.

### 9-2-1. Preparation of Samples A to C

The samples A to C were prepared through the following procedures.

A tungsten oxide (WO₃) layer having a thickness of 50 nm was formed on a 3 cm×3 cm square stainless steel substrate having a thickness of 0.5 mm with a radio-frequency magnetron sputtering apparatus. The temperature of the substrate in sputter deposition was room temperature.

A nickel oxide (NiO) layer having a thickness of 300 nm was then formed on the charge storage layer with the radio-frequency magnetron sputtering apparatus. A 2 cm×2 cm square shadow mask was used. The temperature of the substrate in sputter deposition was room temperature.

Finally, a tungsten (N) layer having a thickness of 150 nm was formed on the nickel oxide layer with the radio-frequency magnetron sputtering apparatus. The temperature of the substrate in sputter deposition was room temperature.

The samples A to C were prepared through these steps. The charge storage devices (samples A to C) had an operation area of 4 cm².

### 9-2-2. Charge-Discharge Test

The charge storage devices of the samples A to C were subjected to a constant current charge-discharge test at a temperature of 25° C. In this test, a charge storage device of each sample was charged at a constant charging voltage of 2 V for 5 minutes and was then discharged to a discharge cut-off voltage of 0 V at a constant discharge current density of 12.5 μA/cm². A Solartron 1470E charge-discharge test apparatus was used.

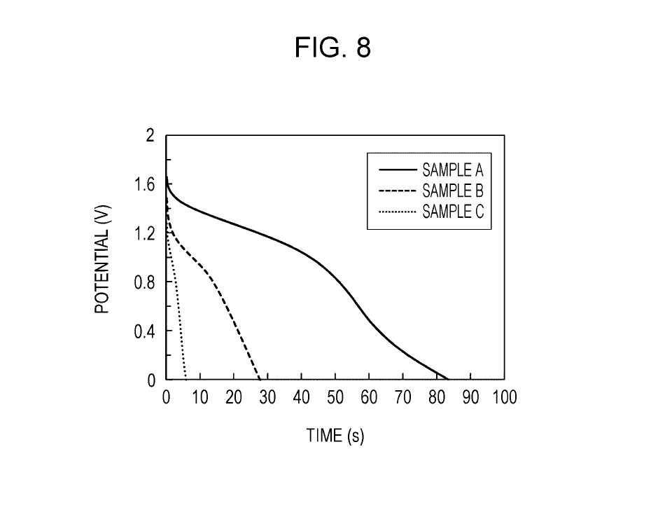

FIG. 8 shows discharge curves of the charge storage devices of the samples A to C. Table 1 lists the discharge capacities of the charge storage devices of the samples A to C based on the charge-discharge test results.

TABLE 1

| | Sample A | Sample B | Sample C |
|---|---|---|---|
| Heating | 100 | 250 | 500 |
| temperature (° C.) | | | |
| Discharge capacity | 996 | 308 | 63 |
| (nWh) | | | |

The charge storage devices of the samples A to C could run charging and discharging operations.

The samples A and B had a discharge capacity of 300 nWh or more. Thus, charge storage devices heated at a heating temperature of 250° C. or less in the drying step (for example, the samples A and B) can be used in applications that require high energy densities. The sample A had a discharge capacity at least three times the discharge capacity of the sample B. Thus, charge storage devices heated at a heating temperature of 100° C. or less in the drying step (for example, the sample A) can be used in applications that require higher energy densities.

The sample C had a discharge capacity of less than 100 nWh. This is probably because high-temperature (i.e., 500° C.) heat treatment caused agglomeration and/or growth of particles in the charge storage layer and thereby changed the particle dispersion state and/or the particle size. The size relationship between the average particle size of titanium oxide particles and the average particle size of silicon oxide particles in the sample C may be different from the size relationship in the samples A and B.

### 9-3. Average Particle Size and Charge-Discharge Characteristics

The discharge capacity of a charge storage device was measured for various combinations of the average particle size of silicon oxide particles and the average particle size of titanium oxide particles.

Samples A and D to F were used for the measurement. The sample A is the same charge storage device of the sample A described in Section 9-2. The samples D to F are different from the sample A in the average particle size of silicon oxide particles and/or the average particle size of titanium oxide particles and are the same as the sample A in the multilayer structure, shape, and production method of the charge storage device. The discharge capacity was measured by the method described in Section 9-2.

Table 2 lists the average particle size D(Si) of silicon oxide particles, the average particle size D(Ti) of titanium oxide particles, the ratio D(Si)/D(Ti), and the discharge capacity of the samples A and D to F. The average particle sizes of the particles were determined from transmission electron micrographs. The samples A, D, and E correspond to examples of a charge storage device according to the present embodiment, and the sample F corresponds to a reference example.

TABLE 2

| | Sample A | Sample D | Sample E | Sample F |
|---|---|---|---|---|
| D(Si) | 20 nm | 20 nm | 5 nm | 5 nm |
| D(Ti) | 5 nm | 10 nm | 5 nm | 10 nm |
| D(Si)/D(Ti) | 4 | 2 | 1 | 0.5 |
| Discharge | 996 | 3513 | 571 | 223 |
| capacity | | | | |
| (nWh) | | | | |

The samples A and D to F could run charging and discharging operations. Thus, the samples A and D to F could be used as charge storage devices.

Table 2 shows that the samples A, D, and E had a discharge capacity of 500 nWh or more. Thus, charge storage devices in which the average particle size of insulator particles is greater than or equal to the average particle size of semiconductor particles can be used in applications that require high energy densities.

Table 2 shows that the samples A and D had a discharge capacity of 900 nWh or more. Thus, charge storage devices in which the average particle size of insulator particles is at least twice the average particle size of semiconductor particles can be used in applications that require higher energy densities.

The present inventors confirmed by measurements that samples including a charge storage layer containing only titanium oxide particles having an average particle size of 5 nm and samples including a charge storage layer containing only titanium oxide particles having an average particle size of 10 nm did not run charging and discharging operations.

The present disclosure is not limited to these embodiments, modified examples, and examples, and various modifications, addition of constituents, and omission of constituents are possible.

A charge storage device according to an embodiment of the present disclosure can be applied to wearable equipment, portable devices, hybrid vehicles, and electric vehicles, for example.

What is claimed is:

1. A charge storage device comprising:
a first electrode;
a second electrode;
a charge storage layer disposed between the first electrode and the second electrode, the charge storage layer containing a mixture of semiconductor particles and insulator particles, an average particle size of the insulator particles being greater than or equal to an average particle size of the semiconductor particles; and
an oxide layer disposed between the second electrode and the charge storage layer.

2. The charge storage device according to claim 1, wherein the semiconductor particles are dispersed among the insulator particles.

3. The charge storage device according to claim 1, wherein the average particle size of the insulator particles is at least twice the average particle size of the semiconductor particles.

4. The charge storage device according to claim 3, wherein the average particle size of the insulator particles is not more than four times the average particle size of the semiconductor particles.

5. The charge storage device according to claim 1, wherein the average particle size of the insulator particles is in the range of 5 to 100 nm.

6. The charge storage device according to claim 5, wherein the average particle size of the semiconductor particles is in the range of 1 to 20 nm.

7. The charge storage device according to claim 6, wherein the average particle size of the semiconductor particles is in the range of 2 to 10 nm.

8. The charge storage device according to claim 1, wherein the insulator particles contain silicon oxide.

9. The charge storage device according to claim 1, wherein the semiconductor particles contain titanium oxide.

10. The charge storage device according to claim 1, wherein the charge storage layer and the oxide layer are solid.

11. The charge storage device according to claim 10, wherein the charge storage device is an all-solid charge storage device.

12. The charge storage device according to claim 1, further comprising a substrate having a heat resistant temperature of 250° C. or less.

13. The charge storage device according to claim 12, wherein the substrate contains at least one selected from the group consisting of aluminum, copper, and resins.
